(19) United States
(12) Patent Application Publication
(10) Pub. No.: US 2018/0204568 A1
(43) Pub. Date: Jul. 19, 2018

(54) SYSTEM FOR FILTERING POTENTIAL IMMIGRATION THREATS THROUGH SPEECH ANALYSIS

(71) Applicant: ALICIA J. GINSBERG, NEWPORT BEACH, CA (US)

(72) Inventor: ALICIA J. GINSBERG, NEWPORT BEACH, CA (US)

(21) Appl. No.: 15/406,656

(22) Filed: Jan. 13, 2017

(51) Int. Cl. G10L 15/22; G10L 15/25; G10L 15/00; G10L 25/21; G10L 25/51

(52) U.S. Cl. CPC G10L 15/22; G10L 15/25; G10L 25/51; G10L 25/21; G10L 15/005

(57) ABSTRACT

A system for filtering potential border threats through speech analysis. A visual word query generator flashes a sequence of words on a display viewable by a subject. A lip tracking module detects lip feature points of the subject and provides a lip tracking module output signal indicative of response latency. An acoustic energy detector module receives acoustic input from the subject responsive to the sequence of words and converts the acoustic input into wavelength image data and compares the wavelength image data of the subject to average wavelength data of a population of native speakers. An acoustic energy detector module output signal is provided that is indicative of acoustic latency. A language detection processing module receives the lip tracking module output signal and the acoustic energy detector module output signal and provides an indication of articulatory latency and accuracy, providing a filter determining whether the subject is a native speaker.

### BACKGROUND OF THE INVENTION

### 1. Field of the Invention

The present invention relates generally to linguistics and cognitive functioning and more particularly to the filtering of potential immigration threats through speech analysis.

### 2. Description of the Related Art

America's status as a nation of immigrants is being challenged by globalization, which has arguably made migration and terrorism easier. Policymakers have been challenged by immigration problems that have increased in the present years. Immigration policy and reform has received more genuine attention in the present years. Various efforts have focused a wide variety of changes in current policy, including improving border security, strengthening employer verification of employment, establishing a guest worker program, and offering amnesty to illegal immigrants living within the border. Immigration reform must be comprehensive to achieve desired results of security and safety.

A principal problem presented by illegal immigration is security. An immigration reform that enables a safe, orderly legal immigration process is needed. A variety of tools may be used to provide such a process. As will be discussed below the system of the present invention, described below, could be an efficient screening technique that would not be dispositive in determining whether or not a terrorist is attempting to enter, but may actually result in providing more open borders by enhancing a nation's ability to filter potential threats. One way of determining if a person may be a potential threat is if they are lying to immigration personnel when attempting to cross a border. A factor in determining whether immigration personnel should be inquiring further would be the ability to discern if a person is truthful when they answer the immigration officer's questions. As will be discussed below, the present invention involves technology to detect the veracity of a person entering the country.

### SUMMARY OF THE INVENTION

In an embodiment, the present invention is a system for filtering potential immigration threats through speech analysis. The system includes a visual word query generator, a lip tracking module, an acoustic energy detector module, and a first language detection processing module that. The visual word query generator is configured to flash sequence of words on the screen display viewable by a subject. The lip tracking module includes a lip detector system configured to detect the lip features of the subject utilizing computer generated models of normalized face and lip images. The lip tracking module includes a lip model light generator configured to generate light onto the lip feature points. A lip feature input system is positioned to detect and receive timing signals indicative of the movement of the lip feature points. The lip feature input system provides a lip tracking module output signal indicative of response latency. The acoustic energy detector module includes an audio input sensor and a voice input unit. The audio input sensor, which is generally a microphone, configured to receive acoustic input from the subject responsive to the sequence of words and converts the acoustic input into wavelength image data. The voice input unit is configured to receive the wavelength image data and compare the wavelength image data of the subject to the average wavelength data which has already been collected, of a population of native speakers of a predetermined language. The voice input unit thus provides an acoustic energy detector module output signal indicative of acoustic latency. The first language detection processing module is configured to receive the lip tracking module output signal and the acoustic energy detector module output signal. Module provides an indication of articulatory latency and accuracy, thus providing a filter for determining whether the subject is a native speaker of a predetermined language.

Thus, in an embodiment the present invention is a method for filtering potential immigration threats through speech analysis. The method involves flashing a sequence of words on a screen display viewable by a subject utilizing a visual word query generator. A next step in the method involves detecting the lip feature points of the subject utilizing computer generated models of normalized face and lip images, using a lip detector system of a lip tracking module. Light is generated onto the lip feature points, utilizing a lip model light generator of the lip tracking module. Timing signals are detected and received that are indicative of the movement of the lip features, using a lip feature input system of the lip tracking module. The lip feature input system provides a lip tracking module output signal indicative of response latency. An acoustic input from the subject responsive to the sequence of words it is received and the acoustic input is converted into wavelength image data, using an audio input sensor of an acoustic energy detector module. The wavelength image data is received and compared with the wavelength image data of the subject to average wavelength data of a population of native speakers of a predetermined language, using a voice input unit of the acoustic energy detector module. The lip tracking module output signal and the acoustic energy detector module output signal are received by a first language detection processing module that provides an indication of articulatory latency and accuracy, thus providing a filter for determining whether the subject is a native speaker of a predetermined language.

The present invention provides a speech coding and recognition system combining acoustic and visual data which is not susceptible to adverse performance by reliance on fine initial positioning. It can tolerate quick movements of speech which can be robustly tracked, therefore providing much needed stability.

Other objects, advantages, and novel features will become apparent from the following detailed description of the invention when considered in conjunction with the accompanying drawings.

### BRIEF DESCRIPTION OF THE DRAWINGS

FIG. 1 is a schematic diagram of the system for filtering potential immigration threats, of the present invention.

FIG. 2 is a schematic representation of the lip feature points.

FIG. 3 is a schematic illustration of the lip model light generator of the present invention being used with a subject.

FIG. 4 is a schematic representation of the waveform utilized in the present invention.

### DETAILED DESCRIPTION OF THE INVENTION

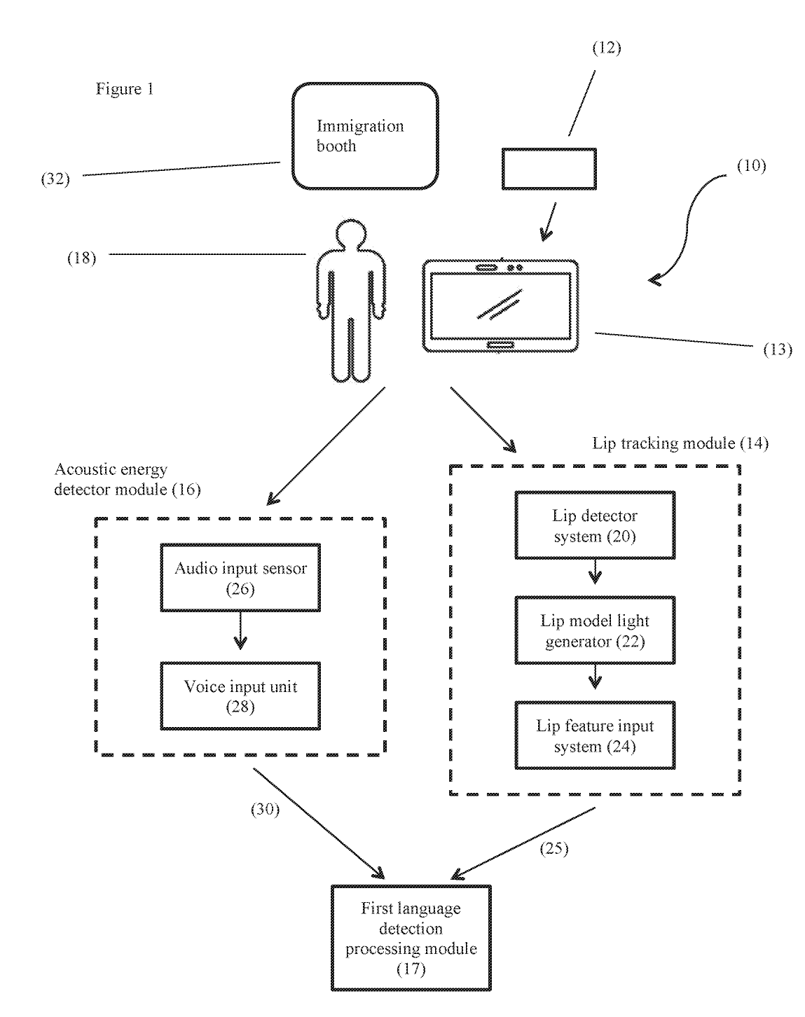

Referring now to the drawings and the characters of reference marked thereon, FIG. 1 illustrates the system for filtering potential immigration threats through speech analysis of the present invention, designated generally as 10. As used herein, the term “potential immigration threats” is meant broadly to include any person attempting to pass through customs, for example, for immigration or temporarily for work or vacation. Therefore, although particularly useful with immigrants, the principles of this invention are also equally applicable to visitors to a country.

The system 10 includes a visual word query generator 12, a lip tracking module 14, an acoustic energy detector module 16, and a first language detection processing module 17. The visual word query generator 12 is configured to flash sequence of words on the screen display 13 viewable by a subject 18. The lip tracking module 14 includes a lip detector system 20 configured to detect the lip features of the subject utilizing computer generated models of normalized face and lip images. The lip tracking module includes a lip model light generator 22 configured to generate light onto the lip feature points. A lip feature input system 24 is positioned to detect and receive timing signals indicative of the movement of the lip feature points. The lip feature input system provides a lip tracking module output signal 25 indicative of response latency.

The acoustic energy detector module 16 includes an audio input sensor 26 and a voice input unit 28. The audio input sensor, which is typically a microphone, configured to receive acoustic input from the subject 18 responsive to the sequence of words and converts the acoustic input into wavelength image data. The voice input unit 28 is configured to receive the wavelength image data and compare the wavelength image data of the subject to the average wavelength data which has already been collected, of a population of native speakers of a predetermined language. The voice input unit 28 thus provides an acoustic energy detector module output signal 30 indicative of acoustic latency.

The first language detection processing module 17 is configured to receive the lip tracking module output signal 25 and the acoustic energy detector module output signal 30. Module 17 provides an indication of articulatory latency and accuracy, thus providing a filter for determining whether the subject is a native speaker of a predetermined language.

The visual word query generator 12 includes a processor for generating a sequence of known words that follow a syntactic structure. The screen display 13 may be, for example, a tablet type screen or any other suitable digital display.

Typically, in use, a subject approaches an immigration officer booth 32. If the subject indicates that their first language is a native language of that country then the system 10 of the present invention is activated. The subject is requested to step in front of the screen display 13.

The lip detector system 20 includes a processing system configured to detect the lip feature point of the subject. In a lip detection step, the face is first detected based on a local binary set pattern by an algorithm, and the lips are suitably detected with respect to an approximate position of lips on the face. Accordingly, in further related embodiments, a lip detector is suitably allowed to learn and determine precise positions of lip feature points for lip reading using normalized face and lip images.

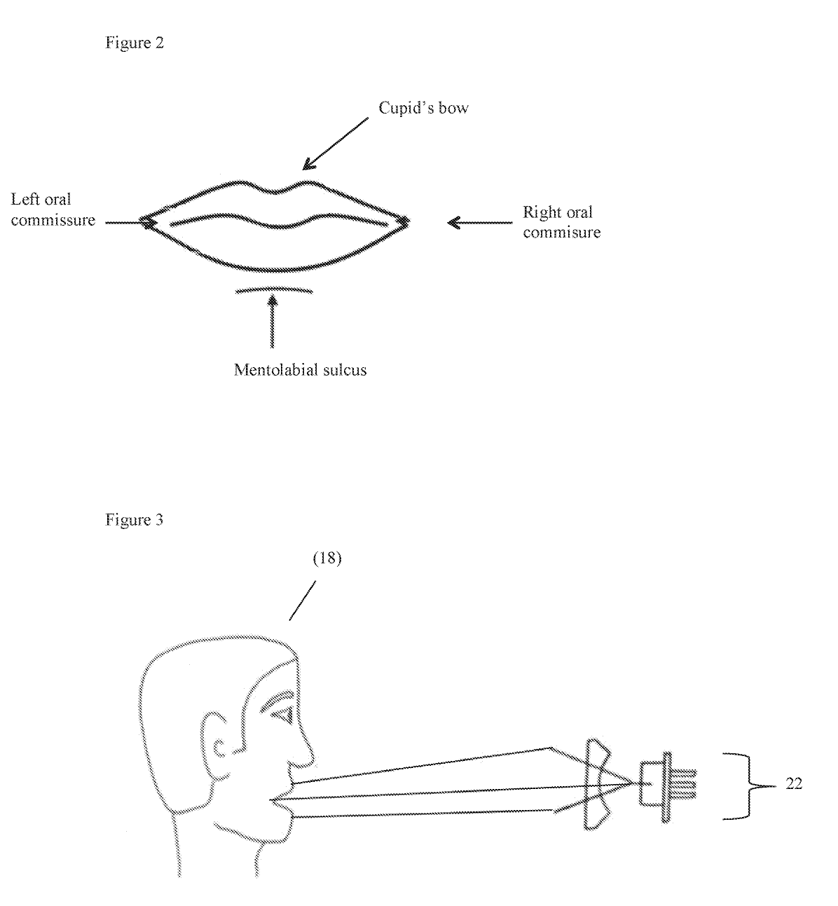

Referring now to FIG. 2, a diagram showing the lip feature points is illustrated, showing the cupid's bow, the right oral commissure, the mentolabial sulcus, and the left oral commissure.

According to certain preferred embodiments of the present invention, the lip detector provides an approximate position of the lips, suitably locates the overall position of the lips using an overall lip model, suitably detects the corners of the lips using a lip corner model, suitably detects the centers of the upper and lower vermillion borders of the lips using a lip center model, and suitably provides the coordinates of the feature points as the initial position values of the lip model light generator 22 for tracking.

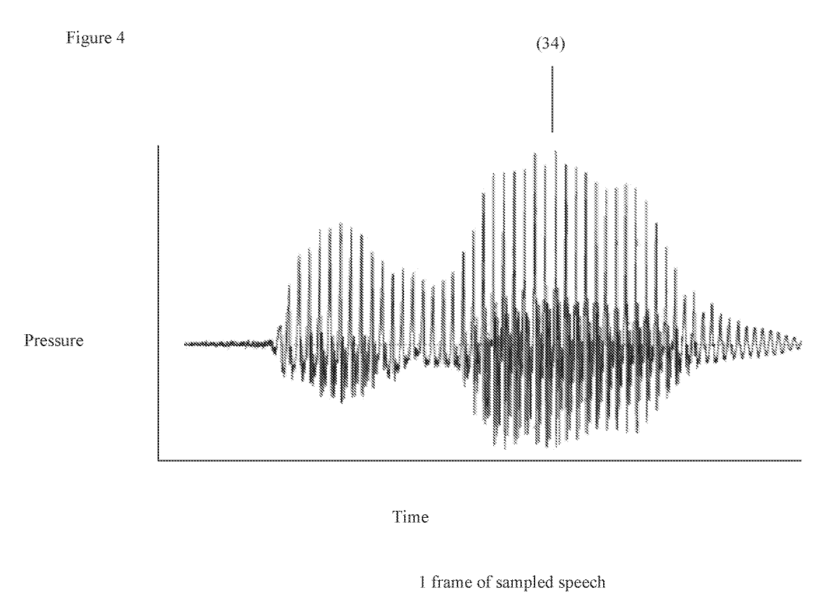

Referring now to FIG. 3, the lip model light generator 22 suitably points to the feature points on the lips, with respect to lip image. The light produced is used for lip feature tracking. The lip model light generator 22 may be, for example, a suitable light laser as known in this field.

Referring again now to FIG. 1, the lip feature input system 24 is typically a camera. The lip feature input system 24 tracks the lip feature points obtained after lip detection by using the shape model generated by the lip detector and highlighted by the lip model light generator, and inputs images obtained. Preferably, the lip tracking result for each input image is suitably provided to the first language detection processing module 17 using a shape parameter as a feature value. The lip feature input system 24 may be configured to communicate with various sensors or recording devices with sensors.

The audio input sensor 26 can use any suitable microphone. An input sound signal can be obtained by converting an acoustic signal input through a given microphone into an electrical signal, as is well known by those skilled in the field. The voice input unit 28 recognizes the acoustic input from a speaker by converting the acoustic input into wavelength image data for processing.

Referring now to FIG. 4, the wavelength image data is represented by the waveform. For each word articulated by the subject, one frame of sampled speech 34 is processed. The waveform is a curve showing the shape of a wave at a given time. The vertical scale represents sound pressure, the horizontal scale represents time. FIG. 4 shows the sound pressure of a particular tone relative to the atmospheric pressure. The magnitude of the sound pressure alterations, measured from 0, is known as amplitude, which corresponds roughly to loudness or audibility. Brief moments of silence occur during occlusions of unvoiced stop constants, or regular breathing pauses dependable on audible respiration. The frequency of a periodic wave is the number of cycles that occur per second, represented by Hertz. Most speech activity occurs between 100 Hz and 8000 Hz. A transient is a sudden and brief burst of acoustic energy that occur in speech as the plosive releases of stop consonants.

Referring again now to FIG. 1, the first language detection processing module 17 suitably converges visual frame data from the lip tracking module and acoustic frame data from the acoustic energy detector module to determine whether the sequence of words from the visual word query generator compares to the data for native speakers of the predetermined language, based on a series of lip model parameters that are obtained as the result of lip tracking on consecutive input images and acoustic frames. Accordingly, the first language detection module suitably determines if the speech data matches or falls within the normal range of that of native speakers of a predetermined language.

The following discussion provides a brief, general description of a suitable computing environment to implement embodiments of one or more of the provisions set forth herein. The operating environment shown is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

FIG. 1 shows examples of computing systems that comprise computing devices configured to implement one or more embodiments provided herein. In one configuration, computing device includes at least one processing unit coupled with memory. Depending on the exact configuration and type of computing device, memory may be volatile (such as RAM, for example), non-volatile (such as ROM, flash memory, etc., for example) or some combination of the two.

In other embodiments, system 10 may include additional features and/or functionality. For example, the devices shown may also include additional storage (e.g., removable and/or non-removable) including, but not limited to, magnetic storage, optical storage, and the like. In one embodiment, computer readable instructions to implement one or more embodiments provided herein may be in storage. Storage may also store other computer readable instructions to implement an operating system, an application program, and the like. Computer readable instructions may be loaded in memory for execution by one or more processing units.

The term “computer readable media” as used herein includes computer storage media. Computer storage media includes volatile and nonvolatile, removable and non-removable media implemented in any method or technology for storage of information such as computer readable instructions or other data. Memory and storage are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by devices of the system 10. Any such computer storage media may be part of the system 10.

System 10 may also include communication connection(s) that allows devices in the system 10 to communicate with other devices. Communication connection(s) may include, but is not limited to, a modem, a Network Interface Card (NIC), an integrated network interface, a radio frequency transmitter/receiver, an infrared port, a Universal Serial Bus (USB) connection, or other interfaces for connecting computing device of system 10 to other computing devices. Communication connection(s) may include a wired connection or a wireless connection. Communication connection(s) may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Devices of system 10 may include input device(s) such as keyboard, mouse, pen, voice input device, touch input device, infrared cameras, video input devices, and/or any other input device. Output device(s) such as one or more displays, speakers, printers, and/or any other output device may also be included in system 10. Input device(s) and output device(s) may be connected via a wired connection, wireless connection, or any combination thereof. In one embodiment, an input device or an output device from another computing device may be used as input device(s) or output device(s) for system 10.

Components of system 10 may be connected by various interconnects, such as a bus. Such interconnects may include a Peripheral Component Interconnect (PCI), such as PCI Express, a Universal Serial Bus (USB), firewire (IEEE 13114), an optical bus structure, and the like. In another embodiment, components of system 10 may be interconnected by a network. For example, memory may be comprised of multiple physical memory units located in different physical locations interconnected by a network.

Those skilled in the art will realize that storage devices utilized to store computer readable instructions may be distributed across a network. For example, a computing device accessible via a network may store computer readable instructions to implement one or more embodiments provided herein. System 10 may access computing devices and download a part or all of the computer readable instructions for execution. Alternatively, system 10 may download pieces of the computer readable instructions, as needed, or some instructions may be executed at computing device 50 and some at computing device 66.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

System 10 may be configured to communicate with a network and or objective data services using a variety of communication protocols. The communications protocols may include but are not limited to wireless communications protocols, such as Wi-Fi, Bluetooth, 3G, 4G, RFID, NFC and/or other communication protocols. The communications protocols may comply and/or be compatible with other related Internet Engineering Task Force (IETF) standards.

The Wi-Fi protocol may comply or be compatible with the 802. 11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006; ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or related and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

System 10 may be configured to communicate with a network and or objective data services using a selected packet switched network communications protocol. One exemplary communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, computing device 50 may be capable of communicating with a network 68 using an X.25 communications protocol. The X.25 communications protocol may comply or be compatible with a standard promulgated by the International Telecommunication Union-Telecommunication Standardization Sector (ITU-T). Alternatively or additionally, system 10 may be configured to communicate with a network and or objective data services, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, system 10 may be configured to communicate with a network and or objective data services, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein. “Circuitry”, as used in any embodiment herein, may comprise, for example, singly or in any combination, hardwired circuitry, programmable circuitry, state machine circuitry, and/or firmware that stores instructions executed by programmable circuitry. An application (“app”) and/or module, as used in any embodiment herein, may be embodied as circuitry. The circuitry may be embodied as an integrated circuit, such as an integrated circuit chip.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

Although the above discussion describes the invention as being applicable to an immigration scenario, the invention mentioned herein may also be easily adaptable to further serve other fields.

1. A system for filtering potential immigration threats through speech analysis, comprising:
a) a visual word query generator configured to flash a sequence of words on a screen display viewable by a subject;
b) a lip tracking module, comprising;
i) a lip detector system configured to detect lip feature points of the subject utilizing computer generated models of normalized face and lip images;
ii) a lip model light generator configured to generate light onto the lip feature points;
iii) a lip feature input system positioned to detect and receive timing signals indicative of movement of the lip feature points, said lip feature input system providing a lip tracking module output signal indicative of response latency;
c) an acoustic energy detector module, comprising;
i) an audio input sensor configured to receive acoustic input from the subject responsive to the sequence of words and convert said acoustic input into wavelength image data;
ii) a voice input unit configured to receive said wavelength image data and compare the wavelength image data of the subject to average wavelength data of a population of native speakers of a predetermined language, thus providing an acoustic energy detector module output signal indicative of acoustic latency; and,
d) a first language detection processing module configured to receive said lip tracking module output signal and said acoustic energy detector module output signal and provide an indication of articulatory latency and accuracy, thus providing a filter for determining whether the subject is a native speaker of a predetermined language.

2. The system of claim 1, wherein said screen display is utilized by an immigration officer and said subject is a person attempting to cross a border.

3. The system of claim 1, wherein said lip feature points comprise a cupid's bow, a mentolabial sulcus, a right oral commissure, and a left oral commissure.

4. The system of claim 1, wherein said lip model light generator comprises a light laser.

5. A method for filtering potential immigration threats through speech analysis, comprising:
a) flashing a sequence of words on a screen display viewable by a subject utilizing a visual word query generator;
b) detecting lip feature points of the subject utilizing computer generated models of normalized face and lip images, using a lip detector system of a lip tracking module;
c) generating light onto the lip feature points, utilizing a lip model light generator of the lip tracking module;
d) detecting and receiving timing signals indicative of the movement of the lip features, using a lip feature input system of the lip tracking module, said lip feature input system providing a lip tracking module output signal indicative of response latency;
e) receiving acoustic input from the subject responsive to the sequence of words and converting said acoustic input into wavelength image data, using an audio input sensor of an acoustic energy detector module;
f) receiving said wavelength image data and comparing the wavelength image data of the subject to average wavelength data of a population of native speakers of a predetermined language, providing an acoustic energy detector module output signal indicative of acoustic latency, using a voice input unit of the acoustic energy detector module; and,
g) receiving said lip tracking module output signal and said acoustic energy detector module output signal and providing an indication of articulatory latency and accuracy, using a first language detection processing module, thus providing a filter for determining whether the subject is a native speaker of a predetermined language.

6. The method of claim 5, wherein said screen display is utilized by an immigration officer and said subject is a person attempting to cross a border.

7. The method of claim 5, wherein said lip feature points comprise a cupid's bow, a mentolabial sulcus, a right oral commissure, and a left oral commissure.

8. The method of claim 5, wherein said lip model light generator comprises a light laser.

9. A system for filtering potential border threats through speech analysis, comprising:
a) a visual word query generator configured to flash a sequence of words on a screen display viewable by a subject;
b) a lip tracking module configured to detect lip feature points of the subject and provide a lip tracking module output signal indicative of response latency;
c) an acoustic energy detector module, configured to receive acoustic input from the subject responsive to the sequence of words and convert said acoustic input into wavelength image data and compare the wavelength image data of the subject to average wavelength data of a population of native speakers of a predetermined language, thus providing an acoustic energy detector module output signal indicative of acoustic latency; and,
d) a language detection processing module configured to receive said lip tracking module output signal and said acoustic energy detector module output signal and provide an indication of articulatory latency and accuracy, thus providing a filter for determining whether the subject is a native speaker of a predetermined language.
